(19) United States
(12) Patent Application Publication
(10) Pub. No.: US 2018/0068177 A1
(43) Pub. Date: Mar. 8, 2018

(54) METHOD, DEVICE, AND NON-TRANSITORY COMPUTER-READABLE RECORDING MEDIUM

(71) Applicant: FUJITSU LIMITED, Kawasaki-shi (JP)

(72) Inventors: Yusuke Sakai, Kawasaki (JP); Tetsuya Okano, Setagaya (JP); Masaharu Arai, Kawasaki (JP)

(73) Assignee: FUJITSU LIMITED, Kawasaki-shi (JP)

(21) Appl. No.: 15/683,027

(22) Filed: Aug. 22, 2017

(30) Foreign Application Priority Data
Sep. 6, 2016 (JP) 2016-174124

(51) Int. Cl. G06K 9/00; G10L 25/63; G06Q 30/06

(52) U.S. Cl. CPC G06K 9/00302; G06Q 30/0617; G10L 25/63; G06K 9/00255

(57) ABSTRACT

A method executed by a computer. The method includes, acquiring a first image of a customer, acquiring a second image of a responder who responds to the customer, identifying the customer based on the first image, acquiring customer information corresponding to the customer, identifying the responder based on the second image, determining a reading authority of the responder, and instructing a terminal of the responder to display information, the information being selected from the customer information in accordance with the reading authority.

### CROSS-REFERENCE TO RELATED APPLICATION

This application is based upon and claims the benefit of priority of the prior Japanese Patent Application 2016-174124, filed on Sep. 6, 2016, the entire contents of which are incorporated herein by reference.

### FIELD

The embodiment discussed herein is related to technology for supporting customer service.

### BACKGROUND

In the related art, guidance systems are known in which guide services are provided to customers (visitors) using robots in regions set in advance such as facilities or streets. In the guidance system, guidance implementer configured with an autonomous moving body implements guidance, details of which include urging a customer, who is determined to be guided as a subject, to move to a target position using voices or videos.

### SUMMARY

According to an aspect of the invention, the method includes, acquiring a first image of a customer, acquiring a second image of a responder who responds to the customer, identifying the customer based on the first image, acquiring customer information corresponding to the customer, identifying the responder based on the second image, determining a reading authority of the responder, and instructing a terminal of the responder to display information, the information being selected from the customer information in accordance with the reading authority.

The object and advantages of the invention will be realized and attained by means of the elements and combinations particularly pointed out in the claims.

It is to be understood that both the foregoing general description and the following detailed description are exemplary and are not restrictive of the invention, as claimed.

### BRIEF DESCRIPTION OF DRAWINGS

FIG. 1 is a diagram illustrating a configuration example of a customer service supporting system according to an embodiment;

FIG. 2 is a diagram illustrating an appearance of a customer service robot;

FIG. 3 is a diagram illustrating driving of the customer service robot;

FIG. 4 is a diagram illustrating response to a customer at a window;

FIG. 5 is a block diagram exemplifying a functional configuration of the customer service supporting system according to the embodiment;

FIG. 6 is a diagram illustrating a customer information DB, an employee information DB, a conversation scenario DB, and customer service information;

FIG. 7 is a diagram illustrating an example of a customer service response to a visitor;

FIG. 8 is a diagram illustrating an operation example of reception supporting in the customer service supporting system according to the embodiment;

FIG. 9 is a flow chart illustrating an example of a process of selecting a conversation scenario;

FIG. 10 is a diagram illustrating an operation example of employee supporting in the customer service supporting system according to the embodiment;

FIG. 11 is a diagram illustrating a display screen in an employee terminal;

FIG. 12 is a diagram illustrating the display screen in the employee terminal; and

FIG. 13 is a block diagram illustrating an example of hardware configuration of a server device according to the embodiment.

### DESCRIPTION OF EMBODIMENT

In the related art described above, a visitor may be guided to move to a window or the like that responds to the visitor. However, there is a problem in that any guide regarding the visitor is not provided to an employee who responds to the visitor, and the employee is not sufficiently supported about customer service at the window or the like to which the visitor is guided to move.

Hereinafter, with reference to drawings, a customer service supporting program, a customer service supporting method, a customer service supporting system, and an information processing device according to an embodiment will be described. A same numeral is given to a configuration having the same function in the embodiment, and overlapping description thereof will be omitted. Also, the customer service supporting program, the customer service supporting method, the customer service supporting system, and the information processing device to be described later in the embodiment are only examples, and are not limited to the embodiment. In addition, each embodiment as follows may be appropriately combined within a non-contradictory range.

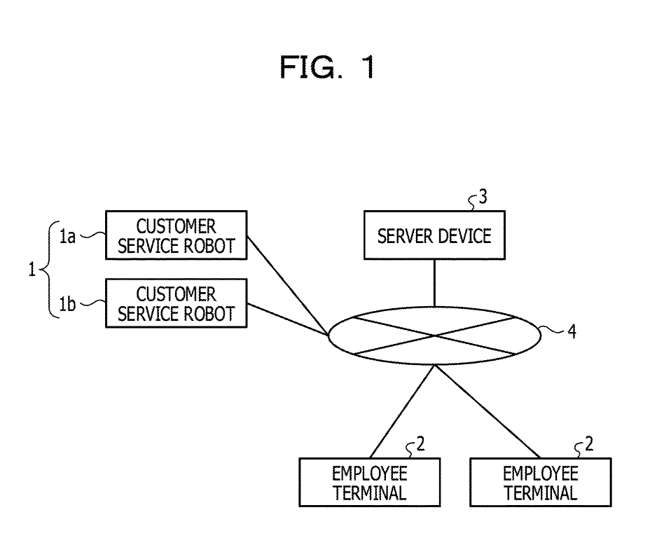

FIG. 1 is a diagram illustrating a configuration example of a customer service supporting system (reception supporting system) according to the embodiment. As illustrated in FIG. 1, the customer service supporting system includes customer service robots 1a and 1b, an employee terminal 2, and a server device 3. The customer service robots 1a and 1b, the employee terminal 2, and the server device 3 are connected to each other so as to be capable of communicating with each other through the communication network 4 such as a local area network (LAN). The customer service supporting system is installed at stores such as financial institutions, and provides service such as reception response or customer service supporting from employees when the visitors are visited. As an example, the customer service supporting system of the embodiment is a system installed at banks.

The customer service robots 1a and 1b are human interface devices which respond to the visitor by having a conversation with the visitor (visiting customer) based on reception supporting service or employee supporting service which is provided by the server device 3. Specifically, the customer service robot 1a is installed at an entrance of a store, a waiting room, or the like, and performs reception response with respect to visitors who visited the store instead of an employee, until the employee responds to the visitor. The customer service robot 1b is installed at a window or the like where the employee responds to the visitor, and supports the employee (responder) when the employee performs the customer service. The customer service robots 1a and 1b will be described as the customer service robot 1 in a case where the customer service robots 1a and 1b are not particularly distinguished from each other.

In the embodiment, the customer service robot 1 is exemplified as an example of the human interface device which responds to visitors. However, the human interface device is not limited to the customer service robot 1 as long as the human interface device is capable of having a conversation with visitors, based on the reception supporting service provided by the server device 3. For example, response may be performed through terminals of the visitors by executing application programs using the reception supporting service provided by the server device 3 in the terminals such as tablet terminals or smart phones of the visitors.

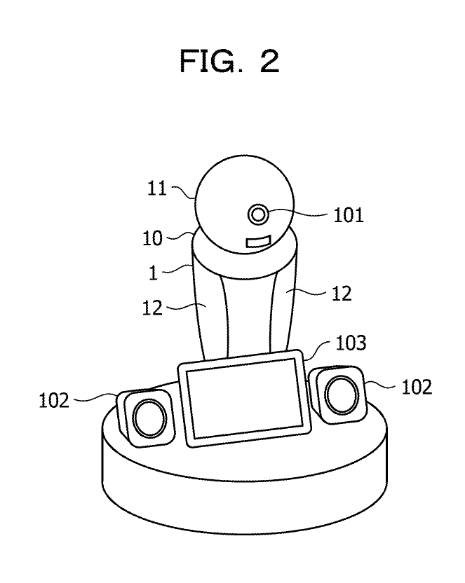

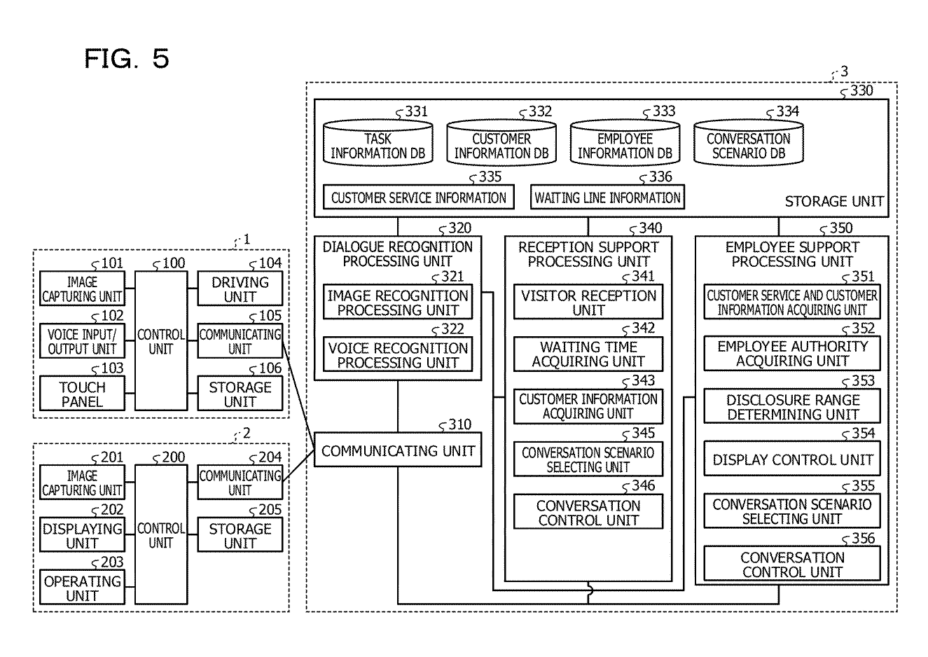

FIG. 2 is a diagram illustrating an appearance of the customer service robot 1. As illustrated in FIG. 2, the customer service robot 1 is a stationary type robot in which a body unit 10 and a head unit 11 are installed in a stand or the like. Arm units 12 are installed in the body unit 10 of the customer service robot 1, and an image capturing unit 101 which captures an image around the customer service robot 1 is installed in the head unit 11. The arm units 12 and the head unit 11 are driven by a driving unit 104 (refer to FIG. 5) installed in the body unit 10.

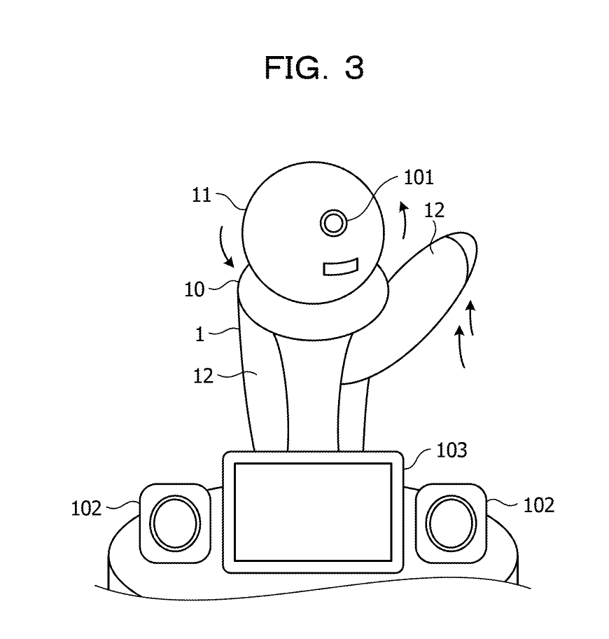

FIG. 3 is a diagram illustrating driving of the customer service robot 1. As illustrated in FIG. 3, the head unit 11 of the customer service robot 1 is rotatably driven around a neck of the body unit 10. Accordingly, the customer service robot 1 is capable of controlling the image capturing unit 101 installed in the head unit 11 so that a capturing direction thereof becomes a direction toward a predetermined subject to be captured. For example, when the employee responds to the visitor, the image capturing unit 101 is capable of facing the visitor or the employee by rotatably driving the head unit 11. In addition, the arm units 12 of the customer service robot 1 are, for example, vertically driven. Accordingly, the customer service robot 1 is capable of responding to the visitor by gestures of the arm units 12.

In addition, voice input/output units 102 and a touch panel 103 are installed in the stand in which the body unit 10 is installed. The voice input/output units 102 are microphones accepting voices and speakers outputting voices. The touch panel 103 displays a screen to a user and accepts touch operations from the user. Also, a configuration of the customer service robot 1 is only an example, and is not limited to illustrated examples. For example, the customer service robot 1 may be an autonomous traveling type robot which is provided with a vehicle device or a traveling device under the body unit 10, and follows and are moved to people (for example, visitors) based on images captured by the image capturing unit 101.

The employee terminal 2 is a terminal device that the employee of a store uses, and a personal computer (PC), a tablet terminal, or the like can be used as the terminal device. As an example, in the embodiment, a stationary type PC, which is stationary at the window where the visitor is responded and used by the employee at the window, is set to the employee terminal 2. The employee terminal 2 receives various services for being used by the employee at the time of the customer service, such as providing task information or customer information, from the server device 3.

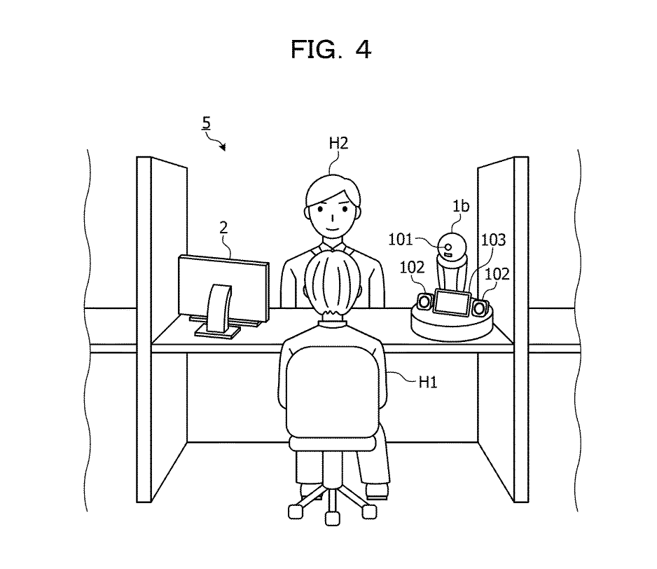

FIG. 4 is a diagram illustrating response to customers at the window. As illustrated in FIG. 4, the window 5 is a position where an employee H2 responds (customer service) to a visitor H1. The window 5 of the illustrated example, is a place where the visitor H1 and the employee H2 face each other with a table therebetween, and the employee terminal 2 and the customer service robot 1b are installed in the table.

The server device 3 sets the customer service robot 1 and the employee terminal 2 as clients, and provides various services to the clients. For example, the server device 3 provides a reception supporting service when the visitor H1 is responded by receiving images of the visitor H1 captured by the image capturing unit 101 or voices of the visitor H1 accepted by the voice input/output unit 102 from the customer service robot 1 and controlling conversations of the customer service robot 1. In addition, the server device 3 provides an employee supporting service, for example, when the employee H2 performs the customer service on the visitor H1 by providing various pieces of information such as the task information or the customer information to the employee terminal 2 in accordance with requests from the employee terminal 2.

FIG. 5 is a block diagram exemplifying a functional configuration of the customer service supporting system according to the embodiment. As illustrated in FIG. 5, the customer service robot 1 includes a control unit 100, a driving unit 104, a communicating unit 105, and a storage unit 106, in addition to the image capturing unit 101, the voice input/output unit 102, and the touch panel 103 described above.

The control unit 100 controls operations of the customer service robot 1 by sequentially executing programs stored in the storage unit 106. The driving unit 104 is a motor or the like which performs driving of the head unit 11 or the arm units 12 based on controlling of the control unit 100.

The communicating unit 105 is a communication interface communicating with the server device 3 through the communication network 4 based on controlling of the control unit 100. For example, the communicating unit 105 transmits images captured by the image capturing unit 101 or voices accepted by the voice input/output unit 102 at the time of responding to the visitor H1 to the server device 3, and receives control information relating to a conversation with the visitor H1 from the server device 3. The control unit 100 outputs voices from the voice input/output unit 102 based on the information received from the server device 3 through the communicating unit 105. Accordingly, the customer service robot 1 is capable of having a conversation with the visitor H1.

The storage unit 106 is, for example, a read only memory (ROM) or a random access memory (RAM), and stores programs or various data for controlling the customer service robot 1. As the various data stored in the storage unit 106, there are, for example, conversation scenarios of a standard specification such as inquiring after or asking business the visitor H1, information received by the server device 3, and the like.

The employee terminal 2 includes a control unit 200, an image capturing unit 201, a displaying unit 202, an operating unit 203, a communicating unit 204, and a storage unit 205.

The control unit 200 controls operations of the employee terminal 2 by sequentially executing programs stored in the storage unit 205. The image capturing unit 201 is a camera capturing images of the employee H2 or the like using the employee terminal 2. The displaying unit 202 is a liquid crystal display and displays various screens based on controlling of the control unit 200. The operating unit 203 is an operating device such as a keyboard or a mouse, and accepts operations of the employee H2. The communicating unit 204 is a communication interface communicating with the server device 3 through the communication network 4. The storage unit 205 is a storage device such as a ROM, a RAM, or a hard disk device, and stores programs or various data for controlling the employee terminal 2.

The server device 3 includes a communicating unit 310, a dialogue recognition processing unit 320, a storage unit 330, a reception support processing unit 340, and an employee support processing unit 350.

The communicating unit 310 is a communication interface communicating with the customer service robot 1 or the employee terminal 2 through the communication network 4. For example, the communicating unit 310 receives the images (for example, images of visitor H1) captured by the image capturing unit 101 or the voices (for example, voices of visitor H1) accepted by the voice input/output unit 102 from the customer service robot 1. The communicating unit 310 outputs information received from the customer service robot 1 to the dialogue recognition processing unit 320. In addition, the communicating unit 310 receives control information relating to a conversation with the visitor H1 from the reception support processing unit 340 or the employee support processing unit 350, and transmits the information to the customer service robot 1. In addition, the communicating unit 310 receives display information relating to displaying a screen of the employee terminal 2 from the employee support processing unit 350 and transmits the information to the employee terminal 2.

The dialogue recognition processing unit 320 is a processing unit which recognizes images and voices accepted from the customer service robot 1, based on the images captured by the image capturing unit 101 or the voices input by the voice input/output unit 102, which are received from the customer service robot 1 when performing reception at an entrance or responding at the window 5. Specifically, the dialogue recognition processing unit 320 includes an image recognition processing unit 321 and a voice recognition processing unit 322, and outputs a recognition result to the reception support processing unit 340 and the employee support processing unit 350.

The image recognition processing unit 321 performs predetermined processes of image recognition. Specifically, the image recognition processing unit 321 specifies a face area from the captured image of the image capturing unit 101 with a well-known face recognition technique, and recognizes a face of the visitor H1, the employee H2, or the like captured by the customer service robot 1.

In addition, based on an image of a face (face information) recognized from the captured images of the image capturing unit 101, the image recognition processing unit 321 specifies a person who captured by comparing the image and face information stored in the storage unit 330. For example, the image recognition processing unit 321 specifies a customer registered in a customer information DB 332 from the face, which is recognized from the captured image of the image capturing unit 101, by obtaining face information of which a degree of similarity is equal to or more than a predetermined value when compared with face information of the customer information DB 332. In addition, the image recognition processing unit 321 specifies the employee H2 registered in an employee information DB 333 from the face, which is recognized from the captured image of the image capturing unit 101, by obtaining face information of which the degree of similarity is equal to or more than a predetermined value when compared with the face information of the employee information DB 333. In addition, the image recognition processing unit 321 specifies the visitor H1 registered in customer service information 335 from the face, which is recognized from the captured image of the image capturing unit 101 by obtaining face information of which a degree of similarity is equal to or more than a predetermined value when compared with the face information of the customer service information 335.

The voice recognition processing unit 322 performs predetermined processes of voice recognition. Specifically, the voice recognition processing unit 322 extracts voices of a person from voices input by the voice input/output unit 102 with a known voice recognition technique. Subsequently, the voice recognition processing unit 322 recognizes conversation details of people with reference to dictionary data of languages which become subjects to be recognized, based on the extracted voices of the people. Accordingly, the server device 3 is capable of recognizing the conversation details at the time of responding, from the voices input by the voice input/output unit 102, which are accepted at the time of responding to the visitor H1.

In addition, the dialogue recognition processing unit 320 may recognize emotions of people based on faces recognized by the image recognition processing unit 321 or voices of the people recognized by the voice recognition processing unit 322. Specifically, the dialogue recognition processing unit 320 is capable of obtaining evaluation values of emotions indicating delight, anger, sorrow, and pleasure of people by inputting the recognized face information or voice information to an application programming interface (API) which is provided by a known cognitive service (computing).

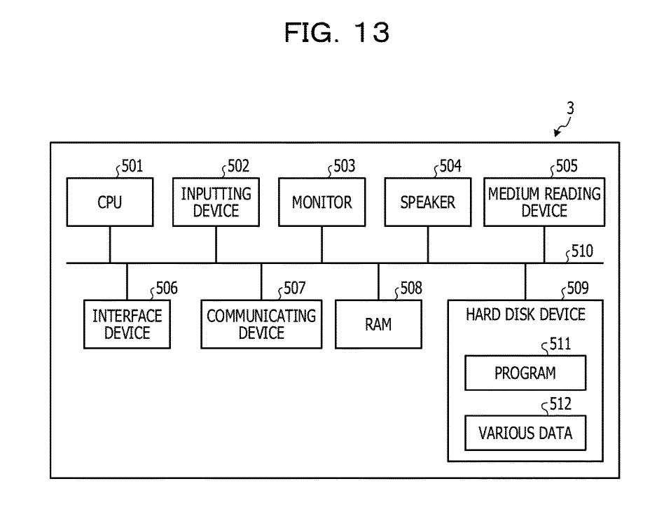

The storage unit 330 is, for example, a hard disk device 509 (refer to FIG. 13), and stores various data used for processes of the server device 3. Specifically, the storage unit 330 stores a task information DB 331, the customer information DB 332, the employee information DB 333, a conversation scenario DB 334, the customer service information 335, and waiting line information 336.

The task information DB 331 is a database in which information about various tasks at a store are stored. The customer information DB 332 is a database in which information relating to customers of the store is stored. The employee information DB 333 is a database in which information relating to the employee H2 of the store is stored. The conversation scenario DB 334 is a database in which information of conversation scenarios where scenarios relating to conversations performed by the customer service robot 1 are described are stored. The customer service information 335 is information which is issued at the time of reception of the visitor H1 by the customer service robot 1a and indicates the details of the customer service relating to the visitor H1 in the store. The waiting line information 336 is information indicating waiting of response to each the employee H2.

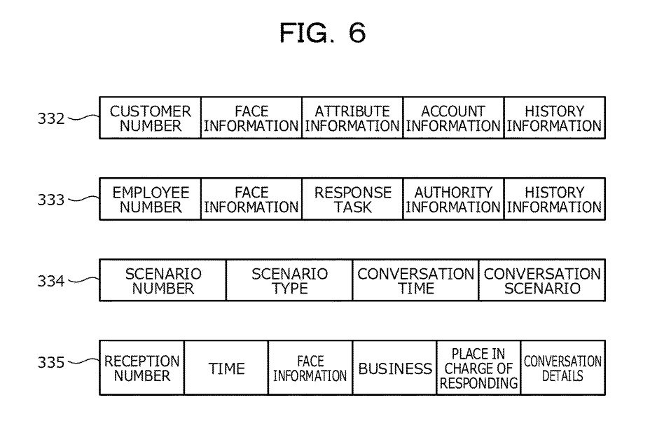

Here, the customer information DB 332, the employee information DB 333, the conversation scenario DB 334, and the customer service information 335 in association with the reception supporting service or the employee supporting service provided by the server device 3 will be described in detail. FIG. 6 is a diagram describing the customer information DB 332, the employee information DB 333, the conversation scenario DB 334, and the customer service information 335.

As illustrated in FIG. 6, the storage unit 330 is a database in which information (face information, attribution information, account information, and history information) relating to each customer in each “customer number” for identifying the customer is stored. The “face information” is, for example, a face image of the customer. The “attribute information” is information indicating attributes such as an address or a name of the customer. The “account information” is information indicating account details of the customer. The “history information” is information indicating histories of the customer such as transactions details with the customer.

The employee information DB 333 is a database in which information (face information, response task, authority information, and history information) of each employee are stored in each “employee number” for identifying the employee H2. The “face information” is, for example, face images of the employee H2. The “response task” is information indicating details of tasks of which the employee H2 responds (for example, various applications such as account opening, transmission of money, inheritance, and moving).

The “authority information” is information indicating authorities that the employee H2 has. For example, the “authority information” may also indicate a reading authority indicating a disclosure range of the information, in addition to authorities on personnel such as administrative staffs, professional staffs, and general staffs. With reference to the “authority information”, the disclosure range of information corresponding to the authorities that the employee H2 has can be determined. For example, based on the authorities on personnel, the disclosure range may be determined, so that an administrative position has the entire information, a professional position has information relating to response tasks themselves, a general position has the entire information with high security except predetermined information (for example, “account information”). In addition, the disclosure range may be determined, based on any stage among the authorities within the disclosure range of information, which are divided into many stages.

The “history information” is information indicating histories of processes in duties performed by the employee H2 from past to the present. For example, in the “history information”, information (network address of employee terminal 2 and the like) for identifying the employee terminal 2 that the employee H2 currently uses is included. In addition, in the “history information”, details of response of the visitor H1 that the employee H2 is processing or already processed are included. By referring to the “history information”, it is possible to specify the employee terminal 2 that the employee H2 uses, to specify whether or not the employee H2 is currently responding, to check a history of responding of the employee H2, and the like.

The conversation scenario DB 334 is database in which each scenario information (scenario type, conversation time, or conversation scenario) in each “scenario number” for identifying the conversation scenario is stored. The “scenario type” is information indicating types of conversations according to the conversation scenarios. For example, a case of a conversation relating to an application procedure such as moving is set to an “application”, a case of a conversation relating to account opening is set to an “account opening”, a case of a conversation which is not limited to particular types is set to “chat”, and the like as the “scenario type”.

The “conversation time” is information indicating conversation time in a case where conversation is performed according to the conversation scenario. In the “conversation time”, time estimated in advance is set, based on details of the conversation scenario.

The “conversation scenario” is information indicating scenarios relating to conversations that the customer service robot 1 performs. For example, the “conversation scenario” is represented as a tree structure in which the scenarios branch in accordance with conversation details or emotions of the visitor H1 recognized using the dialogue recognition processing unit 320, with respect to details of responding to the visitor H1.

The customer service information 335 stores information (time, face information, business, place in charge of responding, and conversation details) indicating details of the customer service with respect to each visitor H1 in each “reception number” identifying the visitor H1 who met with a reception at an entrance or the like.

The “time” is information indicating a reception time of the visitor H1 who met with the reception. The “face information” is images of a face of the visitor H1 who met with the reception. The “business” is information indicating business of the visitor H1 who met with the reception. In the “business”, a business (for example, moving procedure or the like) recognized from conversations with the visitor H1 at the time of reception is stored. The “place in charge of responding” is information indicating the employee H2 who is in charge of responding to the visitor H1 who met with the reception. In the “place in charge of responding”, “employee number” or the like indicating the employee H2 determined as the place in charge of responding is stored. The “conversation details” are information indicating details of the conversation when the customer service robot 1 responds to the visitor H1 who met with the reception. In the “conversation details”, the conversation details with the visitor H1 recognized by the dialogue recognition processing unit 320 are stored.

Back to FIG. 5, the reception support processing unit 340 performs processes relating to the reception supporting service provided by the server device 3. Specifically, the reception support processing unit 340 includes a visitor reception unit 341, a waiting time acquiring unit 342, a customer information acquiring unit 343, a conversation scenario selecting unit 345, and a conversation control unit 346.

The visitor reception unit 341 acquires images of a face and a business of the visitor H1, which is accepted by the customer service robot 1a, and determines the employee H2 (place in charge of responding) who responds to the visitor H1. Specifically, the visitor reception unit 341 acquires the images of face and business of the visitor H1, based on a recognition result in which the capturing images and input voices when the customer service robot 1a responds to the visitor H1 are recognized by the dialogue recognition processing unit 320. Subsequently, based on the acquired business, the visitor reception unit 341 determines the employee H2 who is set for a response task corresponding to a business with reference to the “response task” of the employee information DB 333. Subsequently, the visitor reception unit 341 issues the customer service information 335 including an accepted time, face information (images of face), business, and the place in charge of responding to the visitor H1. In addition, the visitor reception unit 341 registers the employee H2 who is in the place in charge of responding to the waiting line information 336.

The waiting time acquiring unit 342 acquires a waiting time until responding to the visitor H1 in the employee H2 who is in the place in charge of responding determined by the visitor reception unit 341. Specifically, the waiting time acquiring unit 342 checks that the employee H2 who is in the place in charge of responding waits or not in order to respond to the visitor with reference to the waiting line information 336. In a case where the employee waits to response, the waiting time acquiring unit 342 estimates of the waiting time of the employee based on conditions of response waiting and the like. In a case where the employee does not wait to response, the waiting time acquiring unit 342 notifies the employee terminal 2 which is currently used by the employee H2 who is in the place in charge of responding, of a fact that there is the visitor H1, with reference to the history information of the employee information DB 333. Subsequently, in a case where there is a reply from the employee terminal 2 with respect to the notification such as a reply of direct responding, the waiting time acquiring unit 342 sets the waiting time to be zero. In addition, in a case where the waiting time until responding is notified, the waiting time acquiring unit 342 sets the waiting time as a waiting time to be taken for notifying.

The customer information acquiring unit 343 acquires customer information of a customer specified by the dialogue recognition processing unit 320 from the customer information DB 332, based on the images of face of the visitor H1.

The conversation scenario selecting unit 345 selects a conversation scenario within the waiting time acquired by the waiting time acquiring unit 342 from among the conversation scenarios of the conversation scenario DB 334. Specifically, the conversation scenario selecting unit 345 selects the conversation scenario of which conversations are expected to be finished within the waiting time based on the “conversation time” of the conversation scenario DB 334.

In addition, the conversation scenario selecting unit 345 selects a conversation scenario matching with the business of the visitor H1 from among a plurality of conversation scenarios in which conversations are expected to be finished within the waiting time, based on the “scenario type” of the conversation scenario DB 334. For example, in a case where the business of the visitor H1 is an application procedure of moving or the like, a conversation scenario matching with a conversation scenario of which the “scenario type” is the “application” is selected. Accordingly, a conversation in a conversation scenario more matching with the business of the visitor H1 can be executed.

In addition, the conversation scenario selecting unit 345 selects a conversation scenario matching with details of setting of the customer information (for example, attribute information or history information) from among the plurality of conversation scenarios in which conversations are expected to be finished within the waiting time, in a case where the customer information of the visitor H1 is acquired by the customer information DB 332. For example, in a case where an application procedure such as moving is included in a past transaction history of the history information, a conversation scenario matching with the conversation scenario of which the “scenario type” is the “application” is selected. Accordingly, based on a history included in the customer information of the visitor H1 or the like, a conversation in the conversation scenario more matching with the visitor H1 can be executed.

The conversation control unit 346 controls the conversations in the customer service robot 1a with the visitor H1, based on the conversation scenario selected by the conversation scenario selecting unit 345. Specifically, the conversation control unit 346 reads information relating to the conversation scenario selected by the conversation scenario selecting unit 345 from the conversation scenario DB 334. Subsequently, the conversation control unit 346 controls utterance details of the voice input/output unit 102 in the customer service robot 1a, in accordance with the “conversation scenario” read out from the conversation scenario DB 334. Specifically, the conversation control unit 346 controls the utterance details of the voice input/output unit 102 by reading the “conversation scenario” of a tree structure according to branches corresponding to conversation details or emotions of the visitor H1, which are recognized by the dialogue recognition processing unit 320.

In addition, the conversation control unit 346 may change the conversation scenario selected by the conversation scenario selecting unit 345, based on the emotions of the visitor H1 recognized by the dialogue recognition processing unit 320. For example, the conversation control unit 346 changes the conversation scenario, in a case where evaluation values indicating delight, anger, sorrow, and pleasure of the visitor H1 recognized by the dialogue recognition processing unit 320 are equal to or more than a predetermined value. In this case, for example, aggravating emotions of the visitor H1 caused by continuously repeating the same scenarios can be suppressed.

In addition, the conversation control unit 346 records (generates) the conversation details recognized by the dialogue recognition processing unit 320, that is, the conversation details with the visitor H1 in the customer service robot 1a in the customer service information 335, and updates the customer service information 335. Accordingly, conversations before the employee H2 responds to the visitor H1 are recorded in the customer service information 335.

The employee support processing unit 350 performs processes relating to the employee supporting service provided by the server device 3. Specifically, the employee support processing unit 350 includes a customer service and customer information acquiring unit 351, an employee authority acquiring unit 352, a disclosure range determining unit 353, a display control unit 354, a conversation scenario selecting unit 355, and a conversation control unit 356.

The customer service and customer information acquiring unit 351 specifies the accepted visitor H1 by acquiring the images of face of the visitor H1 captured using the customer service robot 1b and collating the “face information” of the customer service information 335 and the “face information” of the customer information DB 332. Subsequently, the customer service and customer information acquiring unit 351 acquires the customer service information 335 and the customer information corresponding to the specified visitor H1.

The employee authority acquiring unit 352 specifies the employee H2 by acquiring the face images of the employee H2 captured using the customer service robot 1b and collating the images with the “face information” of the employee information DB 333. Subsequently, the employee authority acquiring unit 352 acquires the “authority information” corresponding to the specified employee H2 from the employee information DB 333.

The disclosure range determining unit 353 determines the disclosure range of information corresponding to authorities that the employee H2 has, based on the “authority information” acquired by the employee authority acquiring unit 352. For example, in a case where the authorities that the employee H2 has are authorities of the professional position related to procedures of moving or the like, the entire information related to response tasks of the procedures is set in a disclosure range, and information such as the “account information” which is not related to the response tasks of him or herself is set in the outside of the disclosure range.

The display control unit 354 generates display information displaying the customer service information 335 and the customer information acquired from the customer service and customer information acquiring unit 351 within the disclosure range determined by the disclosure range determining unit 353. Specifically, the display control unit 354 generates display information indicating information within the disclosure range by hiding information (for example, “account information) deviated from the disclosure range determined by the disclosure range determining unit 353 with a mask process or the like. The generated display information is output to the employee terminal 2 through the communicating unit 310, and is displayed on a screen of the employee terminal 2. Therefore, the customer service information 335 and the customer information of the visitor H1 are displayed on the screen of the employee terminal 2, within the disclosure range where the authorities of the employee H2 are allowed. Accordingly, the employee H2 responding to the visitor H1 can be supported in the customer service supporting system.

In addition, the display control unit 354 generates the display information displaying emotions of the visitor H1, which are recognized by the dialogue recognition processing unit 320. The generated display information is output to the employee terminal 2 through the communicating unit 310, and is displayed on the screen of the employee terminal 2. Therefore, the emotions of the visitor H1, which are recognized by the dialogue recognition processing unit 320 are displayed on the screen of the employee terminal 2. Accordingly, the employee H2 can easily check the recognized emotions of the visitor Hl. Also, when the employee H2 operates the employee terminal 2, the display control unit 354 generates the display information displaying the emotions of the visitor H1 recognized by the dialogue recognition processing unit 320, and outputs the generated display information to the employee terminal 2. Accordingly, in the customer service supporting system, the employee H2 can recognize a status of the emotion of the visitor H1 recognized during performing tasks using the employee terminal 2.

The conversation scenario selecting unit 355 selects a predetermined conversation scenario from among the conversation scenarios of the conversation scenario DB 334 based on instructions from the employee terminal 2 by the employee H2. Specifically, the conversation scenario selecting unit 355 selects the conversation scenario matching with setting details (for example, attribute information or history information) of the customer information from among the plurality of conversation scenarios of the conversation scenario DB 334, in a case where the customer information of the visitor H1 is acquired by the customer service and customer information acquiring unit 351. For example, in a case where an application procedure such as moving is included in the past transaction history in the history information, the conversation scenario, in which the “scenario type” is the “application”, is selected as a matching scenario.

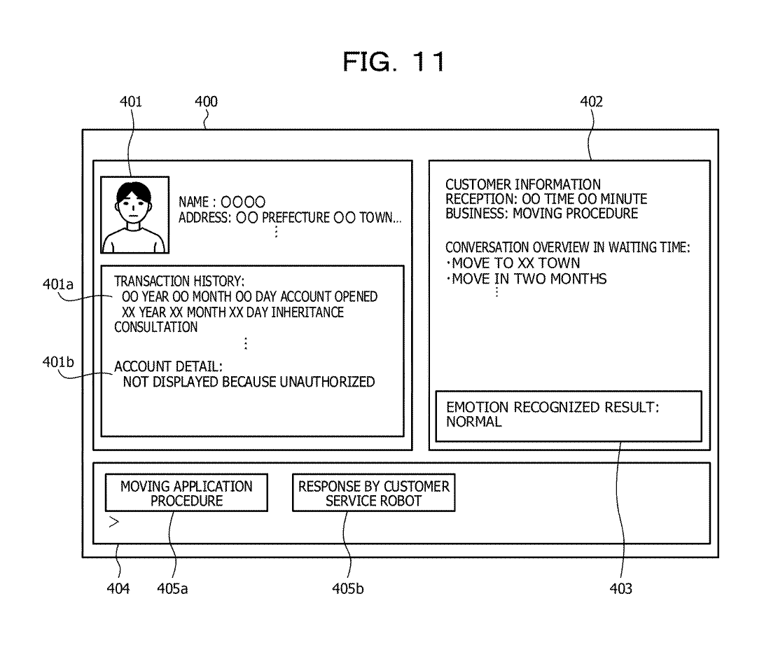

In addition, the scenarios may be selected based on operation instructions of the employee terminal 2. For example, the scenarios may be selected by displaying a list of the scenarios in the conversation scenario DB 334 on a display screen 400 (refer to FIG. 11) of the employee terminal 2, and accepting a selecting operation by the employee H2.

The conversation control unit 356 controls conversations of the customer service robot 1b with the visitor H1 based on the conversation scenario selected by the conversation scenario selecting unit 355. Specifically, the conversation control unit 356 reads out the information of the conversation scenario selected by the conversation scenario selecting unit 355 from the conversation scenario DB 334. Subsequently, the conversation control unit 356 controls the utterance details of the voice input/output unit 102 in the customer service robot 1b according to the “conversation scenario” read out from the conversation scenario DB 334. Specifically, the conversation control unit 356 controls the utterance details of the voice input/output unit 102 by reading the “conversation scenario” of a tree structure according to branches corresponding to the conversation details or emotions of the visitor H1, which are recognized by the dialogue recognition processing unit 320.

In addition, the conversation control unit 356 may change the conversation scenario selected by the conversation scenario selecting unit 355 based on the emotions of the visitor H1, which are recognized by the dialogue recognition processing unit 320. For example, the conversation control unit 356 changes the conversation scenario, in a case where evaluation values indicating delight, anger, sorrow, and pleasure of the visitor H1, which are recognized by the dialogue recognition processing unit 320, are equal to or more than a predetermined value. In this case, for example, aggravating emotions of the visitor H1 caused by continuously repeating the same scenarios can be suppressed.

In addition, the conversation control unit 356 records (generates) conversation details, that is, the conversation details of the customer service robot 1b with the visitor H1 in the customer service information 335, which are recognized by the dialogue recognition processing unit 320, and updates the customer service information 335. Accordingly, the conversation details, when the customer service robot 1b responds to the visitor H1, are recorded in the customer service information 335.

In addition, the conversation control unit 356 may output the display information corresponding to the task details to the customer service robot 1b, based on the task details in a console region 404 (refer to FIG. 11) on the display screen 400 of the employee terminal 2 that the employee H2 uses. Specifically, in a case where operations (tasks) such as a “moving application procedure” or “searching” are performed on the console region 404, display information such as “moving application procedure in progress” or “searching in progress” indicating the task in progress is generated and output to the customer service robot lb. The customer service robot 1b allows the touch panel 103 to display the output displaying information. Accordingly, the task details of the employee terminal 2 that the employee H2 uses may be presented to the visitor H1.

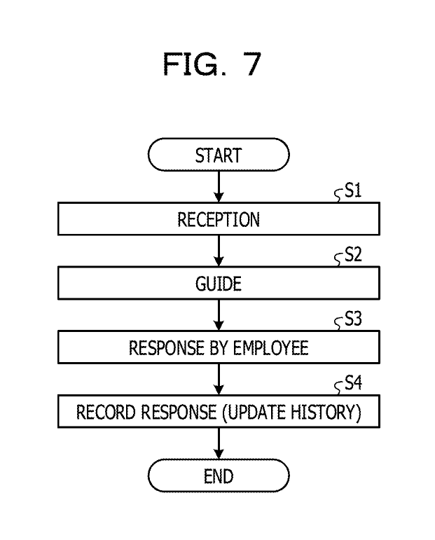

FIG. 7 is a diagram illustrating an example of the customer service response to the visitor H1. As illustrated in FIG. 7, at a store, through the reception supporting service provided by the server device 3, the customer service robot 1a accepts the visitor H1 who visited (S1), and guides the visitor to the employee H2 who responds to (S2).

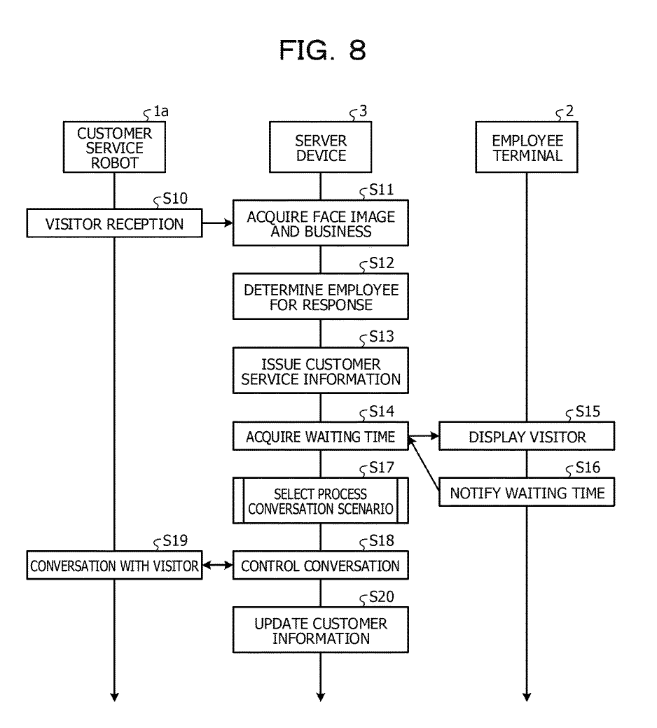

FIG. 8 is a diagram illustrating an operation example of reception supporting in the customer service supporting system according to the embodiment. As illustrated in FIG. 8, the customer service robot 1a responds to the visitor H1 in accordance with the conversation scenario of a standard specification set in advance, such as inquiring after or asking the visitor H1 business, and accepts the visitor H1 (S10). Subsequently, the visitor reception unit 341 of the server device 3 acquires the images of a face and a business of the visitor H1 accepted by the customer service robot 1a (S11).

Subsequently, the visitor reception unit 341 determines the employee H2 who responds by referring to the “response task” of the employee information DB 333 based on the acquired business (S12). Subsequently, the visitor reception unit 341 issues the customer service information 335 in which timing of accepting, face information (face images), a business, and a place in charge of responding to the visitor H1 are included (S13).

Subsequently, the waiting time acquiring unit 342 acquires a waiting time of the employee H2 who responds, which is taken until responding to the visitor H1 (S14). Here, the employee H2 who responds does not wait for response.

In a case where the employee does not wait for response, the waiting time acquiring unit 342 notifies the employee terminal 2, which is currently used by the employee H2 who is in the place in charge of responding, of the visitor H1 with reference to the history information of the employee information DB 333. The notified employee terminal 2 displays the visitor (S15). The employee terminal 2 notifies the server device 3 of the waiting time, based on the operation instructions of the employee H2 (S16). For example, in a case where the response is directly instructed, the waiting time is notified as zero. In addition, in a case where the waiting time until responding is designated, the designated waiting time is notified. As described above, the waiting time may be set according to a status of the employee H2.

Subsequently, the conversation scenario selecting unit 345 performs a process of selecting the conversation scenario of which a conversation scenario within the waiting time acquired by the waiting time acquiring unit 342 is selected from among the conversation scenarios of the conversation scenario DB 334 (S17).

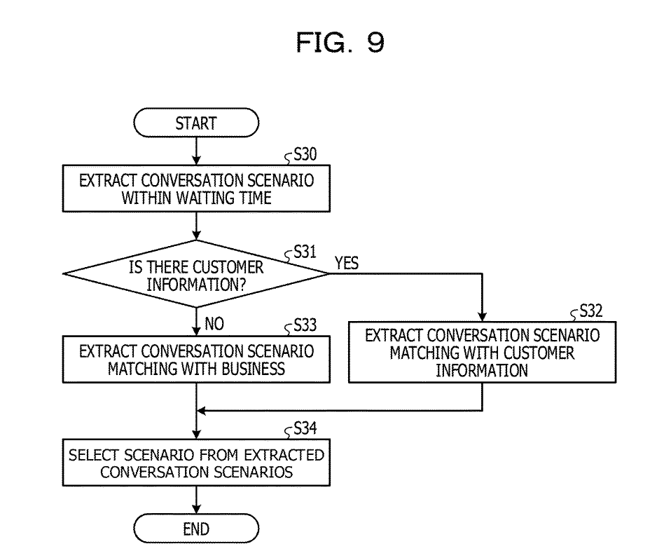

FIG. 9 is a flow chart illustrating an example of the process of selecting the conversation scenario. As illustrated in FIG. 9, if the process starts, the conversation scenario selecting unit 345 extracts the conversation scenario within the waiting time from the conversation scenario DB 334 based on the “conversation time” of the conversation scenario DB 334 (S30). Subsequently, the conversation scenario selecting unit 345 determines whether or not the customer information acquiring unit 343 acquires the customer information (S31).

In a case where the customer information is acquired (YES of S31), the conversation scenario selecting unit 345 extracts a conversation scenario matching with the customer information from among the plurality of conversation scenarios within the waiting time (S32).

In a case where the customer information is not acquired (NO of S31), the conversation scenario selecting unit 345 extracts a conversation scenario matching with the business of the visitor H1 from among the plurality of conversation scenarios within the waiting time (S33). Also, the processes in S33 may be performed after S32.

Subsequently, the conversation scenario selecting unit 345 selects a predetermined conversation scenario from the conversation scenarios extracted in S30 to S33 (S34). In S34, a conversation scenario having a shorter waiting time may be selected. In addition, in S34, a conversation scenario of which a degree of matching is higher in S33 or S32 (degree of matching with business or customer information) may be selected.

Back to FIG. 8, subsequent to 517, the conversation control unit 346 controls conversations of the customer service robot 1a with the visitor H1 based on the conversation scenario selected by the conversation scenario selecting unit 345 (S18). In the customer service robot 1a, a conversation with the visitor H1 is performed based on controlling of the server device 3 (S19). Subsequently, the conversation control unit 346 records conversation details of the customer service robot 1a with the visitor H1 in the customer service information 335, based on the conversation details recognized by the dialogue recognition processing unit 320, and updates the customer service information 335 (S20).

Back to FIG. 7, the employee H2 responds to the visitor H1 who guided to the employee H2 after the waiting time elapses (guides the visitor immediately in a case where there is no waiting time), at the window 5 (S3). At the time of responding, supporting of the customer service is performed with respect to the employee H2 used the employee supporting service provided by the server device 3.

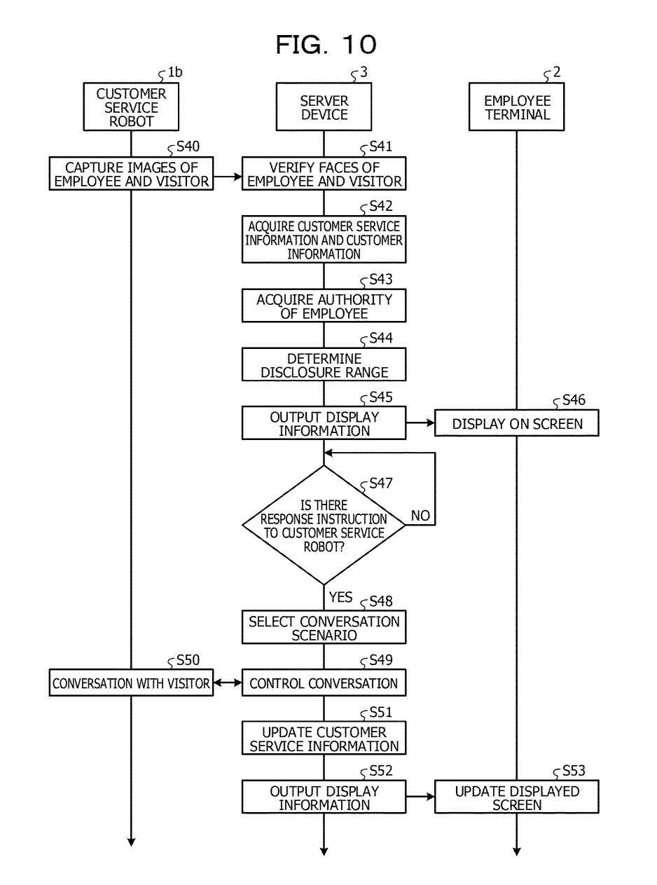

FIG. 10 is a diagram illustrating an example of operations of the employee supporting in the customer service supporting system according to the embodiment. As illustrated in FIG. 10, the customer service robot 1b captures images of the employee H2 who responds to and the visitor H1 at the window 5 (S40), and transmits the captured image to the server device 3.

The customer service and customer information acquiring unit 351 of the server device 3 verifies a face of the visitor H1 by collating the customer service information 335 and face information of the customer information DB 332, based on the face images captured by the customer service robot 1b. In the same manner, the employee authority acquiring unit 352 verifies a face of the employee H2 by collating face information of the employee information DB 333 based on the face images captured by the customer service robot 1b (S41).

Subsequently, the customer service and customer information acquiring unit 351 acquires the customer service information 335 and the customer information corresponding to the visitor H1 specified by face verification (S42). In the same manner, the employee authority acquiring unit 352 acquires the authority information of the employee H2 corresponding to the employee H2 specified by face verification from the employee information DB 333 (S43).

Subsequently, the disclosure range determining unit 353 determines the disclosure range (reading authority) of information corresponding to the authorities that the employee H2 has, based on the authority information of the employee H2 acquired by the employee authority acquiring unit 352 (S44).

Subsequently, the display control unit 354 generates the display information displaying the customer service information 335 and the customer information acquired from the customer service and customer information acquiring unit 351, within the disclosure range determined by the disclosure range determining unit 353. Subsequently, the display control unit 354 outputs the generated display information to the employee terminal 2 through the communicating unit 310 (S45). The employee terminal 2 displays the display information output by the server device 3 on a screen of the displaying unit 202 (S46).

FIG. 11 is a diagram illustrating the display screen in the employee terminal 2. As illustrated in FIG. 11, the display screen 400 includes a customer information displaying region 401 displaying the customer information, a customer service information displaying region 402 displaying the customer service information 335, an emotion displaying region 403 displaying emotions of the visitor H1, and the console region 404 performing various operation instructions.

In the customer information displaying region 401, the customer information within the disclosure range allowed by authorities of the employee H2 is displayed. Specifically, in the customer information displaying region 401, history information 401a within the disclosure range allowed by the authorities of the employee H2 is displayed as it is. In addition, account information 401b out of the disclosure range allowed by the authorities of the employee H2 is displayed as being hidden by, for example, a mask process. The customer service information 335 is displayed as it is in the customer service information displaying region 402 because it is information within the disclosure range allowed by the authorities of the employee H2. In the emotion displaying region 403, the emotions of the visitor H1, which are recognized by the dialogue recognition processing unit 320, are displayed. According to this information, supporting of the employee H2 who responds to the visitor H1 can be performed.

In the console region 404, an operation button 405a for performing a process (moving application procedure in example illustrated in drawing) corresponding to the business of the visitor H1, and an operation button 405b for requesting the customer service robot 1b to respond to the visitor H1 are displayed. The employee H2 can instruct starting of a process such as an application procedure or responding to the visitor H1 using the customer service robot 1b by operating the operation buttons 405a and 405b displayed on the console region 404.

Subsequently, the conversation scenario selecting unit 355 determines instruction or not of responding to the customer service robot 1b, based on instructions from the employee terminal 2 by operating the operation button 405b (S47). In a case where there is no response instruction (NO of S47), the conversation scenario selecting unit 355 waits performing the process.

In a case where there is the response instruction (YES of S47), the conversation scenario selecting unit 355 selects a predetermined conversation scenario from among the conversation scenarios of the conversation scenario DB 334 (S48). The conversation control unit 356 controls conversations of the customer service robot 1b with the visitor H1, based on the conversation scenario selected by the conversation scenario selecting unit 355 (S49).

The customer service robot 1b has a conversation with the visitor H1, based on controlling of the server device 3 (S50). Subsequently, the conversation control unit 356 records conversation details with the visitor H1 in the customer service robot 1b in the customer service information 335 based on conversation details recognized by the dialogue recognition processing unit 320, and updates the customer service information 335 (S51).

Subsequently, the display control unit 354 generates the display information of the updated customer service information 335, and outputs the generated display information to the employee terminal 2 through the communicating unit 310 (S52). Subsequently, the employee terminal 2 updates display details of the customer service information 335 by displaying the display information output by the server device 3 on a screen of the displaying unit 202 (S53).

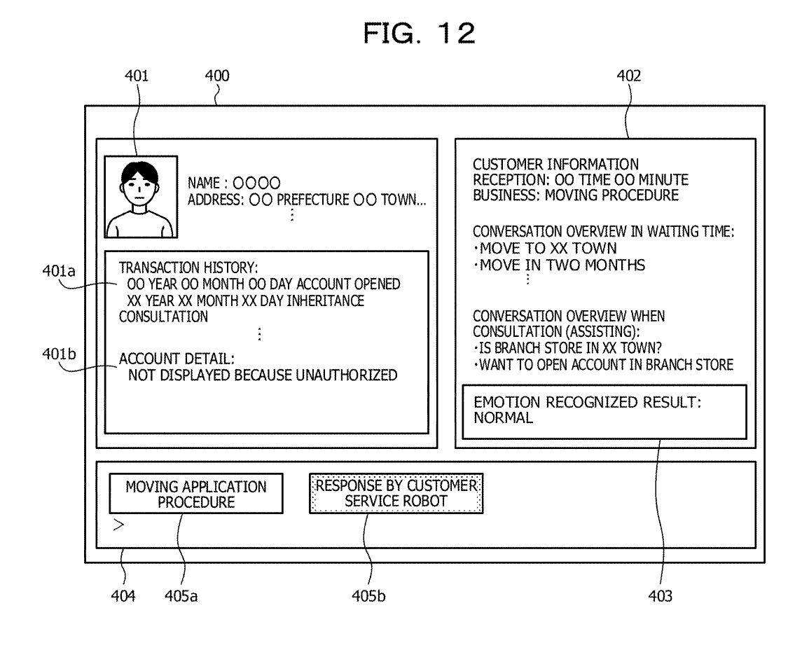

FIG. 12 is a diagram illustrating the display screen 400 in the employee terminal 2. In an example illustrated in FIG. 12, according to operations of the operation button 405b, instruction of response to the visitor H1 is performed by the customer service robot 1b. In the customer service information displaying region 402, by the processes of S51 to S53, conversation details, when the instruction of response to the visitor H1 by the customer service robot 1b is performed, are added. The employee H2 can check the conversation details when the customer service robot 1b responds to the visitor H1 by checking displaying of the customer service information displaying region 402 which is updated as described above.

Back to FIG. 7, recording of response to the visitor H1 is, for example, registered to the “history information” of the customer information DB 332 when the employee H2 operates the employee terminal 2. Accordingly, history updating of the customer information is performed (S4).

As described above, the server device 3 acquires face images of the visitor H1 and the employee H2 who responds to the visitor H1 from the customer service robot lb. In addition, the server device 3 acquires information (for example, customer service information 335 and customer information) corresponding to the visitor H1 which is specified based on the face image of the visitor H1. In addition, the server device 3 acquires the authority of the employee H2, which is specified based on the face image of the employee H2, and determines the disclosure range corresponding to the authority of the employee H2. In addition, the server device 3 outputs the information corresponding to the visitor H1 within the determined disclosure range and displays the information to the employee terminal 2 of the employee H2. Therefore, in customer service supporting system, the employee H2 who responds to the visitor H1 can be supported.

In addition, the server device 3 accepts the instructions from the employee H2 who responds to the visitor H1 through the employee terminal 2. In addition, the server device 3 executes the customer service robot 1b to have a conversation with the visitor H1 based on a predetermined conversation scenario based on the instructions from the employee H2. As described above, the customer service robot 1b is capable of responding to the visitor instead of the employee, for example, when the employee H2 who responds to the visitor H1 leaves his or her seat, by having a conversation with the visitor H1.

Also, each configuration element of each illustrated device is not preferably physically configured as illustrated. That is, a specific figuration of distribution and integration of each device is not limited to a figuration illustrated, and a part or the entire thereof can be configured by being functionally or physically distributed and integrated in an arbitrary unit according to various loads or a use circumstance. For example, a part or the entire functions of the dialogue recognition processing unit 320 may be included in the customer service robot 1 side. In addition, as a first server device including a function of the reception support processing unit 340 and a second server device including a function of the employee support processing unit 350, the functions of the reception support processing unit 340 and the employee support processing unit 350 may be separated.

In addition, an arbitrary part or the entire of various processing functions performed by the server device 3 may be performed using CPU (or microcomputer such as MPU or micro controller unit (MCU)). In addition, it is needless to say that an arbitrary part or the entire of the various processing functions may be performed using programs analyzed by the CPU (or microcomputer such as MPU or micro controller unit (MCU)) or hardware using wired logic. In addition, the various processing functions performed by the server device 3 may be performed by cooperation of a plurality of computers with cloud computing.

However, various processes described with the embodiment described above can be realized by executing the programs stored in advance by a computer. Here, hereinafter, an example of computers (hardware) which include the same functions as that of the embodiment and execute programs will be described. FIG. 13 is a block diagram illustrating an example of a configuration of hardware of the server device 3 according to the embodiment.

As illustrated in FIG. 13, the server device 3 includes a CPU 501 which executes various operation processes, an inputting device 502 which accepts inputting of data, a monitor 503, and a speaker 504. In addition, the server device 3 includes a medium reading device 505 which reads programs and the like from a recording medium, an interface device 506 for connecting various devices, and a communicating device 507 for communicating and connecting to external equipment in wired or wireless manner. In addition, the server device 3 includes a RAM 508 which temporally stores various pieces of information and a hard disk device 509. In addition, each of the units (501 to 509) inside the server device 3 is connected to a bus 510.

In the hard disk device 509, a program 511 for executing various processes in the communicating unit 310, the dialogue recognition processing unit 320, the reception support processing unit 340, and the employee support processing unit 350 described in the embodiment above. In addition, in the hard disk device 509, various data 512 referred by the program 511 (task information DB 331, customer information DB 332, employee information DB 333, conversation scenario DB 334, customer service information 335, waiting line information 336, and the like) are stored. The inputting device 502 accepts, for example, inputting of operation information from operators. The monitor 503 displays, for example, various screens being operated by operators. For example, printing devices and the like are connected to the interface device 506. The communicating device 507 is connected to the communication network 4 such as a LAN, and communicates various pieces of information with the external equipment through the communication network 4.

The CPU 501 reads out the program 511 stored in the hard disk device 509, and performs various processes by developing and executing the processes using the RAM 508. Also, the program 511 may not be stored in the hard disk device 509. For example, the server device 3 may read out and execute the program 511 stored in a readable recording medium. As the recording medium readable by the server device 3, for example, there are portable recording mediums such as CD-ROMs or DVD disks, Universal Serial Bus (USB) memories, semiconductor memories such as flash memories or hard disk drives. In addition, the program 511 may be stored in devices which are connected to public lines, Internet, LANs, and the like, and the server device 3 may read out and execute the program 511 from the devices.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A method executed by a computer, the method comprising:
acquiring a first image of a customer;
acquiring a second image of a responder who responds to the customer;
identifying the customer based on the first image;
acquiring customer information corresponding to the customer;
identifying the responder based on the second image;
determining a reading authority of the responder; and
instructing a terminal of the responder to display information, the information being selected from the customer information in accordance with the reading authority.

2. The method according to claim 1, wherein the customer information is including customer service details before the instructing.

3. The method according to claim 2, wherein the customer service information is generated based on a conversation between a robot and the customer, the conversation being performed between a visiting of the customer and the instructing.

4. The method according to claim 3,
wherein the first image and the second image are captured by a camera included in the robot, and
wherein the first image and the second image are transmitted from the robot to the computer.

5. The method according to claim 1, further comprising:
accepting instructions from the terminal; and
instructing a robot to perform a conversation with the customer based on a conversation scenario, the conversation scenario being selected in accordance with the instructions.

6. The method according to claim 5, wherein the conversation scenario is selected from among a plurality of conversation scenarios based on the customer information.

7. The method according to claim 5, further comprising:
acquiring voice information relating to the conversation recorded by a microphone included in the robot; and
recognizing emotion of the customer based on the voice information.

8. The method according to claim 7, wherein the conversation scenario is selected from among the plurality of conversation scenarios based on the emotion.

9. The method according to claim 5, further comprising: instructing the terminal to display details of the conversation.

10. The method according to claim 9, further comprising:
acquiring voice information relating to the conversation from the robot;
recognizing emotion of the customer based on the voice information; and
instructing the terminal to display the emotion.

11. The method according to claim 1, further comprising:
acquiring operation information relating to operations performed by the responder on the terminal;
specifying task details based on the operation information, the task details indicating one or more tasks which are performed by the responder; and
instructing the robot to display the task details.

12. A non-transitory computer-readable recording medium storing a program that causes a computer to execute a process comprising:
acquiring a first image of a customer;
acquiring a second image of a responder who responds to the customer;
identifying the customer based on the first image;
acquiring customer information corresponding to the customer;
identifying the responder based on the second image;
determining a reading authority of the responder; and
instructing a terminal of the responder to display information, the information being selected from the customer information in accordance with the reading authority.

13. The medium according to claim 12, wherein the customer information is including customer service details before the instructing.

14. The medium according to claim 13, wherein the customer service information is generated based on a conversation between a robot and the customer, the conversation being performed between a visiting of the customer and the instructing.

15. The medium according to claim 14,
wherein the first image and the second image are captured by a camera included in the robot, and
wherein the first image and the second image are transmitted from the robot to the computer.

16. A device comprising:
a memory; and
a processor operatively coupled to the memory and the processor configured to:
acquire a first image of a customer,
acquire a second image of a responder who responds to the customer,
identify the customer based on the first image,
acquire customer information corresponding to the customer,
identify the responder based on the second image,
determine a reading authority of the responder, and
instruct a terminal of the responder to display information, the information being selected from the customer information in accordance with the reading authority.
